(19) United States
(12) Patent Application Publication
(10) Pub. No.: US 2015/0293288 A1
(43) Pub. Date: Oct. 15, 2015

(54) DEVICE AND METHOD FOR PROCESSING A LIGHT GUIDE FOR HOMOGENEOUS COUPLING-OUT OF LIGHT

(71) Applicant: Lisa Draexlmaler GmbH, Vilsbiburg (DE)

(72) Inventor: Udo Braun, Bodenkirchen (DE)

(73) Assignee: LISA DRÄXLMAIER GMBH, VILSBIBURG (DE)

(21) Appl. No.: 14/404,075

(22) PCT Filed: May 29, 2013
(86) PCT No.: PCT/EP2013/061058

§ 371 Date: Jun. 19, 2015

(30) Foreign Application Priority Data
May 29, 2012 (DE) 10 2012 208 954.3

(51) Int. Cl. F21V 8/00; B60Q 3/00

(52) U.S. Cl. CPC G02B 6/001; B60Q 3/002

(57) ABSTRACT

A device for processing a light guide includes a first embossing roller and a second embossing roller. The first embossing roller includes a first structured surface configured to rotate with respect to a first axis of rotation. The second embossing roller includes a second structured surface configured to rotate with respect to a second axis of rotation aligned parallel to the first axis of rotation. The first and second structured surfaces are configured to contact two opposite sides of the light guide. The first and second embossing rollers are configured to guide the light guide between the first and second embossing rollers.

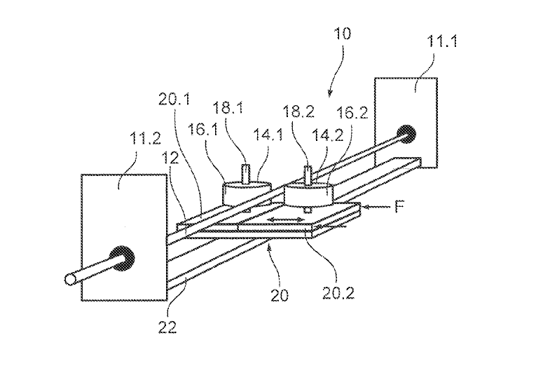

### CROSS-REFERENCE TO RELATED APPLICATIONS

This is a U.S. National Phase of PCT/EP2013/061058, filed May 29, 2013, which claims the benefit of priority to German Patent Application No. 10 2012 208 954.3, filed May 29, 2012, the contents of both of which are incorporated herein by reference.

### TECHNICAL FIELD

The present invention relates to a device for processing a light guide for homogenous coupling-out of light as well as an appropriate method for processing a light guide.

### BACKGROUND

Light guides principally provide the option of providing the interior of a motor vehicle or a similar space with special light effects such as ambient lighting and the like. For light to couple out of the light guide in an appealing way and not only from its front face, the light guide has to be processed. Normally, a light guide guides light by total reflection at its lateral boundary areas, from a front face entry and to a front face exit end, and it is generally not desired that light couples out of the light guide on the way because said loss is no longer available at the exit end. Therefore, conventional light guides are designed and produced so that a lateral coupling-out of light from the light guide is avoided, if at all possible.

Therefore, to obtain an even lateral coupling-out of light from the light guide along its expansion, the surface of a conventional light guide has to be processed. In the prior art, this is often done manually, by processing the surface of a light guide at the places provided for coupling-out light with abrasive paper and polishing agents or similar auxiliary agents. The goal of said processing of the edge of the light guide surface is to specifically damage the boundary surface of the light guide at that place to weaken or completely avoid the total reflection at that place and therefore allow light to escape from the light guide at that place.

A large-scale manual processing of light guides can be realized only with a very high effort in terms of personnel and the cost related thereto. Furthermore, with manual processing, it is especially difficult to ensure a continuous product quality and reproducibility.

To automate the processing of the surface of a light guide, DE 103 57 981 B3 discloses a method where a light guide fiber is pulled through a container filled with bulk material. The bulk material in the container roughens the surface of the light guide because of the relative movement between light guide and the bulk material in the container, which leads to a statistically well distributed surface processing. However, what is disadvantageous about this method is that it allows little influence of the bulk material with respect to the intensity and form of the surface processing. Therefore, said automated surface processing allows only a very limited spectrum of surface processing.

WO 2010/090992 A1 discloses the roughening of light guide surfaces in general, for example by using abrasive paper to couple-out light laterally from the light guide. However, the method disclosed in said document also allows only a limited choice of surface structures and the related coupling-out characteristics.

EP 1 489 441 A1 discloses a special device to emboss light guide substrates to facilitate a lateral coupling-out of light from the light guide. Said specification relates to a planar fiber-optical substrate that is provided on one side with a surface structure by a roller or a structured table. This is disadvantageous because said method and the related device are too imprecise in the processing of individual fibers and therefore can be used only to a limited extent for the processing of surfaces of individual fibers.

### SUMMARY

Given the background of the prior art, the object of the present invention is to provide a device and a method of the aforementioned technical field, which facilitates a processing of the surface of an individual fiber-shaped light guide, which is at the same time efficient, high quality, and reproducible.

The problem is solved with a device according to Claim 1 and the method according to Claim 8. Other advantageous characteristics of the invention follow from the subordinate claims.

The device according to the invention comprises at least two embossing rollers, each having a structured surface for contacting two opposite sides of the light guide, with the axes of rotation of the two embossing rollers being aligned in parallel, and the embossing rollers being designed to guide the light guide between them. Said embodiment according to the invention allows a double-sided embossing of the surface of a fiber-shaped, e.g. essentially one-dimensional expanded light guide, which preferably has a diameter of less than 1 mm, in particular preferably a diameter of less than 0.8 mm. This results in a particularly efficient and precise processing of the light guide. The embossing rollers have a surface structure in the form of embossments, for example protrusions, which can be embossed into the surface of the light guide by pressing onto the surface of the light guide. Said embossing creates a light guide with a defined surface structure which, for example, can be exactly reproduced and adjusted with respect to the density and depth as well as the form of the embossments. Therefore, the scattering characteristic of the light guide can also be precisely adjusted at the surface imperfection generated by the embossing.

In the present text, a light guide is understood to be an optical fiber, which, for example, as a glass fiber has an essentially one-dimensional expansion. Said light guide can be available as continuous material and preferably consists of a polymer. The light guide is preferably not encased.

The casing of an optical light guide, which is common and called “cladding” in some fields, is therefore removed in the processing of the light guide according to the invention either prior to the processing, or the light guide is already delivered without said encasing.

The embossing rollers are preferably coated, in particular galvanically coated guide rollers that are supported on a mechanical cross-axis accommodation.

The device preferably comprises a carriage on which the embossing rollers are positioned to travel along an orientation of the light guide. The orientation of the light guide is specified by the device, for example by suitable accommodations for the light guide, between which the light guide can be clamped. By developing the device with a traversable carriage, the embossing rollers can easily act on the light guide at various places along the length of the light guide and therefore process said light guide essentially over its entire length. Alternately, it is also conceivable that the light guide is moved through the embossing rollers while the embossing rollers are positioned on a firm pedestal.

Advantageously, at least one of the embossing rollers, which are arranged in pairs, is positioned in such a fashion that a force that is predefined by at least one of the two embossing rollers, preferably a resilience, can be applied in the direction of the other of the two embossing rollers. In other words, one of the two embossing rollers is positioned on a pedestal that is pre-tensioned in the direction of the other embossing roller, and because of the pre-tensioning force applied by the first embossing roller on the second embossing roller via the pedestal, an embossing force is created between the embossing rollers, which is suitable for embossing the light guide. Preferably, the resilience can be individually adjusted, for example by using different springs, or the springs as such are adjustable.

However, alternately it is also possible to press the two embossing rollers onto each other by using an electrical motor or a hydraulic- or pneumatic element. Finally, the two embossing rollers can also be positioned in a firm distance to one another, which makes it possible to determine the embossing force between the two rollers on the light guide, for example with the diameter and the elasticity of the light guide.

In a preferred embodiment, the device furthermore comprises a clamping tool to tension the light guide with a definable tensioning force along the light guide. The light guide can be therefore be clamped into a clamping tool of this type in such a fashion that it is tensioned in its longitudinal direction by said device. The advantage of this, for example, is that the twist generated by the positioning of the light guide can be removed. Preferably, the clamping tool is designed for this purpose so that the clamping tool facilitates an independent torsion of individual ends of the light guide about its longitudinal axis.

Preferably, the clamping tool has a rotation means in which the complete light guide can be rotated about its longitudinal axis. The rotating means is designed in particular to latch the light guide in discreet angle distances. Said angle distances are in particular 120°, 90°, 60°, 45° or 30°. Unlike the previously mentioned option of rotating individual ends of the light guide about its longitudinal axis with the clamping tool, the rotation means therefore provides the option of rotating the complete light guide about its longitudinal axis. In this way, the typically cylindrical lateral surface of the light guide can be processed especially evenly and defined. Principally, it is possible that the rotation means also rotates the light guide continuously to ensure an especially even processing of the lateral surface of the light guide. However, because of a simplified reproducibility, it is preferred to provide discreet angle distances. Said angle distances are typically also called indexing.

In addition, another conceivable design of the device allows a rotation of the embossing rollers about the light guide. This creates the option of embossing the entire overleaf surface of the light guide. The realization of a rotation of the embossing rollers in angular distances of 120°, 90°, 60°, 45° or 30° is advantageous, which ensures a complete embossing of the light guide in multiple work cycles.

An alternate embodiment includes the use of a plurality of embossing rollers arranged in pairs. Preferably, the device therefore provides at least six embossing rollers arranged in pairs, which are offset in 60° angles relative to one another. In this way, a rotation of the light guide or the embossing rollers is not absolutely necessary to emboss the entire overleaf surface of the light guide. It appears sufficient to guide the light guide through or along the embossing rollers. Alternately, devices with four as well as eight and more embossing rollers are also possible.

In a preferred embodiment of the device, the surface of the embossing rollers comprises an abrasive paper, in particular a diamond abrasive paper, which preferably has a grain size of 600 to 1400, or the embossing rollers are coated with diamonds. The surface of the embossing roller with diamonds is particularly suited as embossing surface because the fine protrusions exert a high local force on the surface of the light guide. In the embodiment with grinding paper surface, the embossing rollers are also used for embossing, but not for grinding the surface of the light guide.

A method according to the invention for processing a light guide comprises an embossing of the peripheral surface of the light guide in that the light guide is guided between at least two rollers with structured surfaces, which are rotated in such a fashion that their structured surfaces emboss the peripheral surface of the light guide on opposing sides. It is also conceivable to guide the rollers along a fixed light guide, which leads to the same effect.

To obtain a complete embossing of the overleaf surface of the light guide, the rollers can be rotated about the light guide in various angular distances, or the light guide as such can be rotated. An arrangement of a plurality of pairs of rollers is also possible, which does not require various angular settings of the rollers or the rotation of the light guide during embossing. Preferably, the rollers are positioned at an angle of between 90° and 30°, in particular at an angle of 60° relative to one another, which means that the entire overleaf surface can be embossed in one work cycle.

Preferably, one of the rollers, which are arranged in pairs, exercises a definable force on the light guide in the direction of the other of the two rollers, which results in the advantages described above.

Preferably, the rollers are respectively positioned and rotated in such a fashion that at a contact point between each of the rollers and the light guide, a slippage between light guide and roller is avoided. This characteristic is principally related to the embossing of the surface of the light guide and insofar represents a clear limitation compared to a grinding of the surface, where a relatively high relative speed is obtained between the surfaces acting in the processing. The grinding surface grinds over the ground surface with significant slippage. In the embossing according to the invention, on the other hand, the relative speed between the embossing rollers and the light guide is optimally adjusted to the rotation speed of the embossing rollers so that each slippage between light guide and roller is suppressed, if possible, and a relative speed of the processing surfaces is suppressed. The embossing leads to an excellent quality of the light guide structure and a high reproducibility. A grinding process, on the other hand, is an uncontrolled and imprecise method, which leads to an undesired irregular structure on the surface of the light guide during processing.

Preferably, the light guide is tensioned in its longitudinal direction to allow an especially precise surface processing, in particular in view of a possible twist within the light guide, which can be reduced by tensioning the light guide.

Preferably, a previously described device according to the invention is used with the method according to the invention.

In principle, the details of the invention described above can be varied without deviating from the idea of the invention. In particular the described materials and angle ranges can vary, which can be selected according to the light guide to be processed.

The method according to the invention can be applied directly to a delivered light guide, and it can also be performed in connection with an upstream homogenization process. In such a homogenization process, the base material of the light guide can be pre-processed, for example in view of the twist properties when the light guide is delivered as continuous material, or in view of the removal of a possibly originally intended encasing of the light guide.

The method can be performed with manual as well as electronic control. For an electronic control, it is preferred that the relative speed between the embossing rollers and the light guide as well as the pressing pressure is adjusted and realized by appropriate actuators. For example, in this case, it is preferred to realize the pressing pressure of the embossing rollers on the light guide with an electric motor, for example a step motor or the like.

With the invention described above, it is possible to realize a processing of a light guide for generating a defined surface structure, which, for example, can be used for the production of a light guide suitable for ambient lighting, which is cost-efficient but nevertheless meets the high quality requirements of the automotive industry.

### BRIEF DESCRIPTION OF THE FIGURE

The FIGURE shows a schematic representation of a preferred device for processing a light guide.

### DESCRIPTION OF THE EMBODIMENTS

The FIGURE shows a schematic view of a preferred device 10 for processing a surface of a light guide 12. The device 10 has two parts 11.1, 11.2 of a clamping tool into which a light guide 12 is clamped. The light guide 12 runs between the parts 11.1, 11.2 of the clamping tool in such a fashion that it is guided between two embossing rollers 14.1, 14.2. The embossing rollers 14.1, 14.2 have a respective overleaf surface 16.1, 16.2 which has a respective surface structure that can be transferred to the lateral surface of the light guide 12.

The embossing rollers 14.1, 14.2 are positioned on axes 18.1, 18.2, which are respectively positioned perpendicular to the direction of extension of the light guide 12 and parallel to one another. Both axes 18.1, 18.2 are located on a carriage 20, which is traversable via a guide rail 22 along the direction of extension of the light guide 12. The guide rail 22 connects the two parts 11.1, 11.2 of the clamping tool so that the embossing rollers 14.1, 14.2 can essentially act on the light guide 12 along the entire length of said light guide on the carriage 20.

The carriage 20 comprises two parts 20.1, 20.2, with a first part 20.1 of the carriage 20 being essentially immovable in perpendicular direction to the guide rail 22. A second part 20.2 of the carriage 20, on the other hand, is movable relative to the first part 20.1 and therefore also relative to the guide rail 22 and the light guide 12 perpendicular to the extension of the light guide 12, and loaded with a resilience that exerts a continuous pressure of the embossing roller 14.2 on the light guide 12 located between said embossing roller and the embossing roller 14.1.

The two parts 11.1, 11.2 of the clamping tool are preferably designed in such a fashion that they facilitate, independent of one another, a rotation of the light guide 12 clamped therein at its respective end and about its longitudinal axis. In doing so, the light guide 12 is preferably tensioned and held by the clamping tool 11.1, 11.2 and can be relieved of a twist by a rotation of a part of the clamping tool 11.2, 11.2, and rotated about its longitudinal axis by simultaneously rotating the parts 11.1, 11.2 of the clamping tool relative to the embossing rollers 14.1, 14.2. Said rotation is preferably possible in indexing distances of 120°, 90°, 60°, 45° or 30°, with a respective discreet latching of the corresponding rotation device of the clamping tool being provided.

The guide rail 22 can be developed in one piece or multiple pieces, for example with one or a plurality of dovetail guides or profile rails. A multi-part guide rail 22 can increase the stability of the device 10 and is therefore preferred.

In addition to the loading with resilience, the second part 20.2 of the carriage 20 can also be pressed against the first part 20.1 and the light guide 12 by an electric motor, such as a step motor or a hydraulic or pneumatic element.

The distance between the parts 11.1, 11.2 of the clamping tool is preferably about 1.5 meters to 2 meters and allows the mechanical clamping of a light guide of corresponding length or a part of a longer light guide. The pressure or the force with which the two embossing rollers 14.1, 14.2 are pressed against each other and therefore against the light guide 12 guided between them can be adjusted based on the material of the light guide, in particular based on its elasticity and deformability.

With the device described above, the method according to the invention can be applied to a light guide in an especially preferred manner, and said light guide can therefore be processed especially efficiently and precisely reproducibly to obtain an ambient lighting or similar light effects in the interior of a motor vehicle or a similar space.

1-13. (canceled)

14. A device for processing a light guide, comprising:
a first embossing roller including a first structured surface configured to rotate with respect to a first axis of rotation; and
a second embossing roller including a second structured surface configured to rotate with respect to a second axis of rotation aligned parallel to the first axis of rotation,
wherein the first and second structured surfaces are configured to contact two opposite sides of the light guide, and
wherein the first and second embossing rollers are configured to guide the light guide between the first and second embossing rollers.

15. The device according to claim 14, wherein the first and second embossing rollers are configured to process the light guide, the light guide having a diameter of less than 1 mm.

16. The device according to claim 14, further comprising:
a carriage configured to support the first and second embossing rollers,
wherein the first and second embossing rollers are positioned on the carriage to traverse along an alignment direction of the light guide.

17. The device according to claim 14, wherein the first embossing roller is configured to apply a predefined force in a direction toward the second embossing roller.

18. The device according to claim 17, wherein the first embossing rollers is configured to apply a resilience in the direction toward the second embossing roller.

19. The device according to claim 14, further comprising:
a clamping device configured to clamp the light guide with a definable tensioning force along the light guide when the light guide is guided between the first and second embossing rollers.

20. The device according to claim 14,
wherein the first and second embossing rollers form a first pair of embossing rollers,
the device further comprising:
a second pair of embossing rollers including a third embossing roller and a fourth embossing roller,
wherein an angle between the first pair of embossing rollers and the second pair of embossing rollers is between 30° and 90°.

21. The device according to claim 20, further comprising:
a third pair of embossing rollers including a fifth embossing roller and a sixth embossing roller,
wherein a first angle between the first pair of embossing rollers and the second pair of embossing rollers is 60° and a second angle between the second pair of embossing rollers and the third pair of embossing rollers is 60°.

22. The device according to claim 14, wherein at least one of the first or second structured surface includes an abrasive paper.

23. The device according to claim 22, wherein the abrasive paper includes a diamond abrasive paper having a grain size of 600 to 1400.

24. The device according to claim 14, wherein at least one of the first or second structured surface is coated with diamonds.

25. A method for processing a light guide, comprising:
guiding the light guide between at least two rollers having structured surfaces; and
embossing, by the structured surfaces, an overleaf surface of the light guide on opposite sides.

26. The method according to claim 25, wherein guiding the light guide between the at least two rollers includes guiding the light guide between a plurality of rollers arranged in pairs at an angle between 90° and 30° relative to each other.

27. The method according to claim 25, wherein guiding the light guide between the plurality of rollers includes guiding the light guide between six rollers arranged in pairs at an angle of 60° relative to each other.

28. The method according to claim 25, further comprising:
exerting, by one of the at least two rollers, a definable force on the light guide in a direction toward another one of the at least two rollers.

29. The method according to claim 25, further comprising positioning and rotating the at least two rollers in such a manner that avoids a slippage between the light guide and at least two rollers.

30. The method according to claim 25, further comprising tensioning the light guide in its longitudinal direction.
